(19) United States
(12) Patent Application Publication
(10) Pub. No.: US 2014/0140584 A1
(43) Pub. Date: May 22, 2014

(54) METHOD AND APPARATUS FOR GENERATING PERSONAL INFORMATION OF CLIENT, RECORDING MEDIUM THEREOF, AND POS SYSTEMS

(71) Applicant: In Kwon Lee, Seoul (KR)

(72) Inventor: In Kwon Lee, Seoul (KR)

(73) Assignee: Pramor LLC, Hoffman Estates, IL (US)

(21) Appl. No.: 14/003,718

(22) PCT Filed: Aug. 2, 2012
(86) PCT No.: PCT/KR2012/006177

§ 371 Date: Sep. 6, 2013

(30) Foreign Application Priority Data
Aug. 9, 2011 (KR) 10-2011-0078962

(51) Int. Cl. G07C 9/00; G06K 9/00

(52) U.S. Cl. CPC G07C 9/00158; G06K 9/00221
USPC 382/118

(57) ABSTRACT

This invention is a method and a device for generating customer's personal information, a computer-readable recording medium and a POS system. It is organized into the following three stages as a method for generating customer's personal information for a POS system composed of POS terminals and all the servers or a network server: (a) stage where the above customer's facial area is detected from the image extracted from the image input via an image input apparatus installed at the task location of the above POS terminal; (b) stage where a facial feature point is detected from the facial area extracted above; and (c) stage where at least one of the information related to the above customer's gender and age is estimated based on the facial area and the facial feature point extracted above to generate personal information.

### TECHNOLOGICAL FIELD

This invention is a method and a device for generating customer's personal information, a computer-readable recording medium and a POS system.

To be specific, this invention intends to detect a customer's facial feature points from the images extracted from the images input via an image input apparatus installed at the task location of a POS terminal, use these facial feature points and generate customer's personal information such as a customer's gender and age and purchasing information in order to generate many different types of statistics based on a customer's purchasing information by gender and age.

### INVENTION TECHNIQUES

In general, a POS terminal is a device used to collect, memorize and transmit data such as the name or price of a product at a point of sale at a retail store, a supermarket or a sales outlet as a system terminal or a terminal for a store.

This POS terminal is mainly used at most large sales outlets such as Emart and Homeplus because it not only calculates the amount of sales but also collects and handles many different types of information and data, which are needed for the retail management.

As stated earlier, a POS terminal has a barcode reader, an electronic device for reading printed barcodes automatically.

When this barcode reader reads the barcode printed on a product packaging paper, many different types of information related to the corresponding product are automatically printed out.

If a POS terminal is used, the sales flow of products sold at a large sales outlet can be identified by unit product.

Moreover, many different types of information such as the sales trend and the time period of new and promotional products, products in sluggish sales and the sales trend compared with similar products or competing products can be identified in detail. Therefore, the marketing strategies including the correlation between the sale price and sales volume, main targets for sales and advertising plans can effectively be established.

As it identifies information based on the barcode printed on a product packaging paper, the traditional POS terminal can be for generating many different types of statistical information based on a product.

However, it cannot be used to generate many different types of statistical information based on customer personal information such as a customer's age and gender.

In other words, the traditional POS terminal could not be for generating information based on customer's personal information such as customer preferences toward a special product by age and gender.

In this situation, it is required for the technology related to the POS terminal which can generate information based on customer's personal information in addition to information based on a product for the generation of many different types of information.

### INVENTION DESCRIPTION

### Problem Intended to be Solved

The purpose of this invention, intended to solve the above problems of the traditional technology, is to provide a method and a device for generating customer's personal information, a computer-readable recording medium and a POS system, which detect a customer's facial feature points from the images extracted from the images input via an image input apparatus installed at the task location of a POS terminal, use these facial feature points and generate personal information such as a customer's gender and age in order to generate many different types of statistics based on customer's personal information such as purchasing information by gender and age.

### Means to Solve the Problem

A task example implemented to achieve the above purposes in this invention is a method for generating customer personal information for a POS system composed of POS terminals and all the servers or a network server. This method is organized into four stages as follows: (a) stage where the above customer's facial area is detected from the image extracted from the image input via an image input apparatus installed at the task location of the above POS terminal; (b) stage where a facial feature points are detected from the facial area extracted above; and (c) stage where at least one of the information related to the above customer's gender and age is estimated based on the facial area and the facial feature point extracted above to generate personal information.

According to the other aspect of this invention, this invention provides a recording medium which can be read with the computer recording the program intended to implement each stage of the above method for generating customer's personal information.

According to the other side of this invention, this invention provides a POS system using a method for generating customer's personal information.

A task example implemented from another aspect in this invention is a device for generating customer's personal information for a POS system composed of POS terminals and all the servers or a network server. This device is composed of the following three modules: a face detection module which detects the above viewer's facial area from the image extracted from the image input via an image input apparatus installed at the task location of a POS terminal; a facial feature point detection module which detects a facial feature point from the facial area extracted above; a customer information generation module which estimates at least one of the information related to the above customer's gender and age based on the facial area and the facial feature point extracted above to generate personal information.

A task example implemented from another aspect of this invention is a device for generating customer's personal information for the customer management system composed of a customer response terminal and all the servers or a network server. The above customer's facial area is detected from the image extracted from the image input via an image input apparatus installed at the task location of the customer response terminal to generate customer personal information about at least one of the above customer's gender and age.

A task example implemented from another aspect of this invention is a device for generating customer's personal information for the customer management system composed of a customer response terminal and all the servers or a network serverIt is a method for generating customer's personal information for a POS system composed of POS terminals and all the servers or a network server. This method is characterized by the point that the above customer's facial area is detected from the image extracted from the image input via an image input through apparatus installed at the task location of a customer response terminal to generate customer's personal information about at least one of the above customer's gender and age.

### Invention Effects

As stated above, this invention has many advantages.

First, through the use of a POS terminal installed at a retail store, a super market, or a large sales outlet, this invention can generate customer's personal information and the resultant personal statistics in addition to much statistical information based on products.

Second, this invention can estimate and generate personal information about a customer's gender and age only with an image input apparatus (for example, a camera).

Third, this invention has a high reliability of detecting a customer's facial feature points because it determines whether or not the detected facial area is valid and detects a facial feature point in the facial area determined to be valid. Therefore, it improves the tracking performance in the facial area.

Third, this invention has a high reliability of detecting a customer's non-frontal face in the facial area because it uses asymmetric Haar-like features to detect non-frontal face areas. Accordingly, it improves the tracking performance in the facial area.

Lastly, this invention can widely generate extensive customer's personal information because it is applied to an advertising display terminal in addition to a POS terminal.

### BRIEF DESCRIPTION OF DRAWINGS

FIG. 1 is a schematic diagram describing a rough composition of a device for generating customer's personal information in accordance with a task implementation example of this invention.

FIG. 2a is a schematic diagram describing Implementation example 1 for the post system of this invention.

FIG. 2b is a schematic diagram describing Implementation example 2 for the post system of this invention.

FIG. 2c is a schematic diagram describing Implementation example 3 for the post system of this invention.

FIG. 2d is a schematic diagram describing Implementation example 4 for the post system of this invention.

FIG. 3 is a picture marking 28 facial feature points in relation to the generation of customer's personal information in accordance with a task implementation example of this invention.

FIG. 4a is the first picture showing the exemplary screen of an UI module in relation to the generation of customer's personal information in accordance with a task implementation example of this invention.

FIG. 4b is the second picture showing the exemplary screen of an UI module in relation to the generation of customer's personal information in accordance with a task implementation example of this invention.

FIG. 5 is a flowchart describing the process of generating customer's personal information in accordance with a task implementation example of this invention.

FIG. 6 is a drawing describing the basic form of the existing Haar-like features.

FIG. 7 is an exemplary picture of the Haar-like features to detect a customer's frontal face in relation to the generation of customer's personal information in accordance with a task implementation example of this invention.

FIG. 8 is an exemplary picture of the Haar-like features to detect a customer's non-frontal face in relation to the generation of customer's personal information in accordance with a task implementation example of this invention.

FIG. 9 is a drawing describing the newly added rectangular features in relation to the generation of customer's personal information in accordance with a task implementation example of this invention.

FIG. 10 is an exemplary picture of the Haar-like features selected from FIG. 9 to detect a customer's non-frontal face in relation to the generation of customer's personal information in accordance with a task implementation example of this invention.

FIG. 11 is a feature probability curve in the training set about the existing Haar-like features and the Haar-like features applied to this invention.

FIG. 12 is a table describing the features newly added from the training set of a non-frontal face, the dispersion of the probability curve of the existing Haar-like feature and the average value of Kurtosis.

FIG. 13 is the profile picture applied to the existing ASM method for a low resolution or poor quality image.

FIG. 14 is a pattern picture around each landmark used in AdaBoost to search the landmarks of this invention.

FIG. 15 is a flowchart describing the gender estimation process in relation to the generation method of customer's personal information in accordance with a task implementation example of this invention.

FIG. 16 is an exemplary picture to define the facial areas needed for gender estimation in the gender estimation process in relation to the generation method of customer's personal information in accordance with a task implementation example of this invention.

FIG. 17 is a flowchart describing the age estimation process in relation to the generation method of customer's personal information in accordance with a task implementation example of this invention.

FIG. 18 is an exemplary picture to define the facial areas needed for age estimation in the age estimation process in relation to the generation method of customer's personal information in accordance with a task implementation example of this invention.

### DETAILED DESCRIPTION FOR INVENTION IMPLEMENTATION

This invention can be implemented in many different forms without departing from technical aspects or main features.

Therefore, the implementation examples of this invention are nothing more than simple examples in all respects and will not be interpreted restrictively.

Even though the terms such as 1, 2, and others can be used in explaining many components, the above components shall not be limited by the above terms.

The above terms are used only to distinguish one component from the other component.

For example, the first component can be named the second component without departing from the scope of rights in this invention. Similarly, the second component can be named the first component.

The term called “and/or” includes the combination of the plural described and related items or a certain item of the plural described and related items.

When it is mentioned to be “connected” or “linked” to the other component, a certain component may be connected or linked to the other component. However, it would be understood that there may be some other components between them.

On the other hand, when it is mentioned to be directly “connected” or “linked” to the other component, a certain component would be understood that no other component exists between them.

The terms used in this application do not intend to limit this invention, but are used only to explain specific implementation examples.

The singular expression includes plural expressions unless it is apparently different in the context.

The terms such as “include”, “equipped” or “have” in this application intend to designate that the feature, number, stage, movement, component, part or the combination described in the specification exist.

Therefore, it would be understood that the existence or the additional possibility of one or more than one different features, numbers, stages, actions, components, parts and the combination is not excluded in advance.

Unless differently defined, all the terms used here including technical or scientific terms have the same meaning with what is generally understood by one who has common knowledge in the technical field that this invention belongs to.

The terms such as those defined in the dictionary commonly used will be interpreted to have the meanings matching with the meanings in the context of the related technologies. Unless clearly defined in this application, they are not interpreted as ideal or excessively formal meanings.

The desirable implementation examples in accordance with this invention are explained in detail in reference to the drawings attached below.

But, the same reference numbers are given to the same or corresponding components regardless of drawing codes and repeated explanations will be omitted.

The detailed description about the prior related technology will also be omitted when it is judged to blur the gist of this invention in explaining this invention.

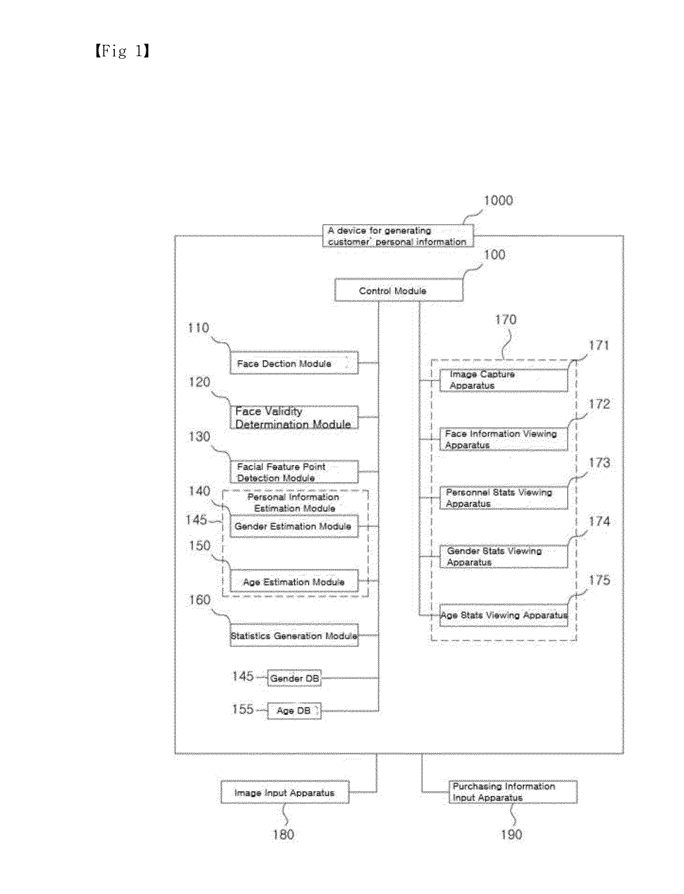

FIG. 1 is a schematic diagram describing a rough composition of a device for generating customer's personal information in accordance with a task implementation example of this invention.

The device for generating customer's personal information (1000) in this implementation example can generate customer's personal information because a generation program for personal information such as a customer's gender and age is installed and driven by a general computer system equipped with computing elements such as a central processing unit (CPU), a system database, a system memory, an interface and others.

Many different types of local or central operating servers, which will be described later, can be used as this computer system.

It will be omitted to explain the general composition of this computer system. Hereafter, the description will be made on the basis of the composition from a functional perspective, which is needed for the explanation of the implementation example of this invention.

Hereafter, the POS system that the device for generating customer's personal information (1000) is realized in this implementation example as stated above will be described.

The POS system in this implementation example is the system which generates many different types of statistics based on customer's personal information such as purchasing information by gender and age by generating personal information such as a customer's gender and age from the images extracted from the images input via an image input apparatus installed at the task location of a POS terminal.

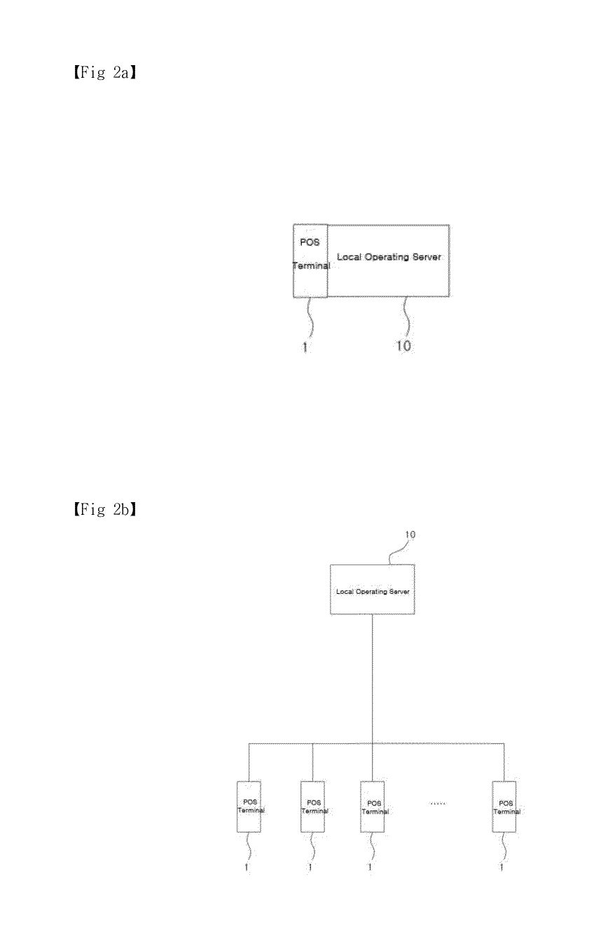

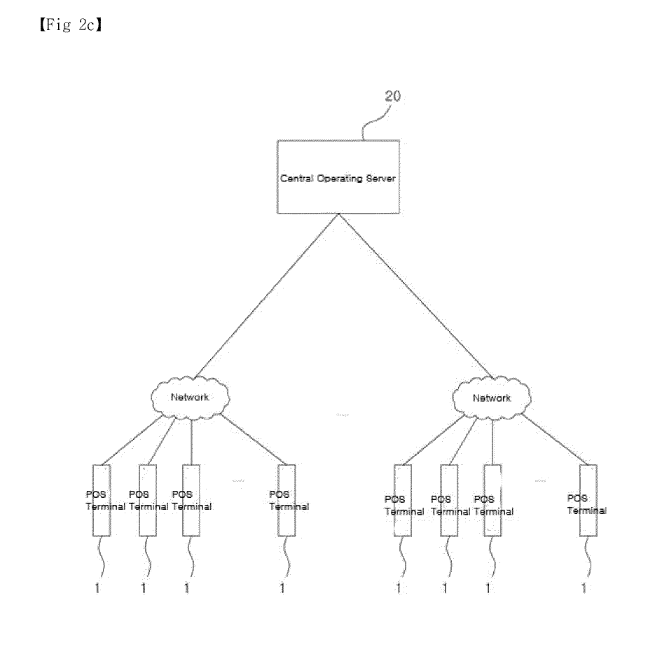

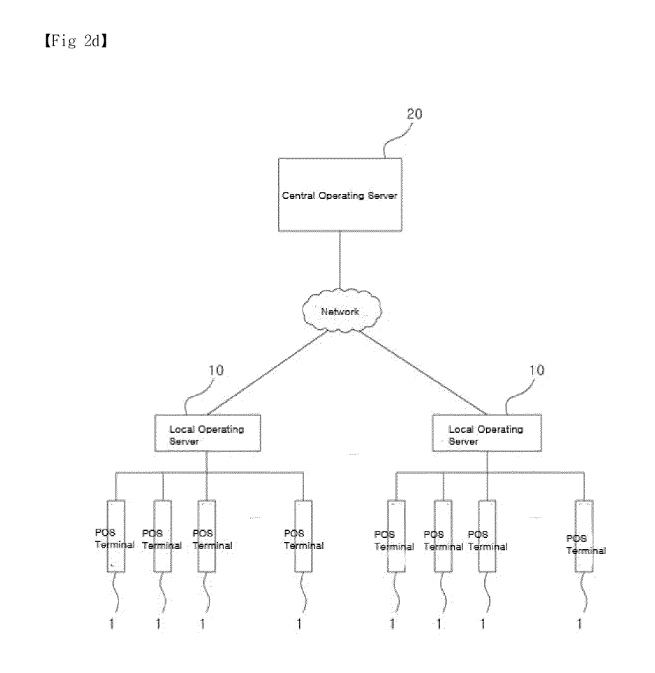

FIG. 2a is a schematic diagram describing Implementation example 1 for the post system which a device for generating customer's personal information is realized in this implementation example.

The post system in Implementation example 1 is composed of a local operating server (10) realized at a single POS terminal (1) as the type of embedded system to be integrally realized.

As the personal information obtained from a POS terminal (1) is transmitted to the above local operating server (10) to be integrally managed, statistical information can be generated.

FIG. 2b is a schematic diagram describing Implementation example 2 for the post system which a device for generating customer's personal information is realized in this implementation example.

As described in FIG. 2b, the post system in Implementation example 2 is composed of plural POS terminals (1) and local operating servers connected to each POS terminal (1).

As the personal information obtained from each POS terminal (1) is transmitted to the above local operating server (10) to be integrally managed, statistical information can be generated.

FIG. 2c is a schematic diagram describing Implementation example 3 for the post system which a device for generating customer's personal information is realized in this implementation example.

As described in FIG. 2c, the post system in Implementation example 3 is composed of plural POS terminals (1) separately installed at plural chain points and a central operating server (20) connected to each POS terminal (1) at each chain point through a network.

Example 3 is composed of plural POS terminals separately installed at plural chain points and a central operating server (20) connected to each POS terminal (1) at each chain point through a network.

As the personal information obtained from each POS terminal (1) installed at each chain point is transmitted to a central operating server (10) through a network such as internet and the above central operating server (20) integrally manage personal information, statistical information can be generated.

FIG. 2d is a schematic diagram describing Implementation example 4 for the post system which a device for generating customer's personal information is realized in this implementation example.

As described in FIG. 2d, the post system in Implementation example 4 is composed of POS terminals (1) and local operating servers (10), separately connected to plural chain points and a central operating server (20) connected to the above POS terminals (1) or the above local operating servers (10) through a network.

Statistical information can be generated through the following three stages: the first stage where the personal information obtained from each POS terminal (1) installed at each chain point is transmitted to the above local operating server (10) to be primarily managed;

the second stage where the personal information and the related purchasing information are transmitted to a central operating server (20) through a network such as internet

The third stage where the above central operating server (20) integrally manages personal information of total chain points

On the other hand, the above POS terminal can be understood as many different types of customer response terminal from a wider perspective

In other words, it can be understood as a terminal responding to plural customers such as a POS terminal responding to a customer's product purchase at a retail store, a super market or a large sales outlet or an advertising display terminal installed at a subway station, a bus stop or an external wall of a building to display advertising screens.

Moreover, it can be understood as other types of terminals responding to plural customers in addition to this kind of POS terminal and advertising display terminal.

In case of an advertising display terminal, the content of the product intended for advertising, which customers (or potential customers) are interested in can be collected and generated as potential purchasing information instead of purchasing information.

Hereafter, the device for generating customer's personal information, which is realized in the POS system, the same as stated earlier, will be described in detail.

The device for generating customer's personal information (1000) in this implementation example has also a face detection module (110).

The above face detection stage (S110) detects the above customer's facial area from the image captured from the image input via an image input apparatus (180),

for example a camera, installed at the task location of the above POS terminal. At this time, the detection angle of view can be all the faces within the range of −90 to +90.

For example, if it is installed toward a customer's face from the task location of a POS terminal (1),

the above image input apparatus (180) can be the camera which the face of a customer who is located at the front can be captured by video in real time or more desirably a digital camera with image sensors.

The personal information which will be described later can be generated with only a single image input apparatus (180) in this implementation example.

The above face detection module (110) performs the following three functions; a function of drawing up the YCbCr color model from the RGB color information of the above extracted image,

The above face detection module (110) separates color and brightness information from the color model drawn up

The above face detection module (110) performs a function of detecting a face candidate area according to the above brightness information

The above face detection module (110) performs a function of defining the rectangular feature point model about the above detected face candidate area

The above face detection module (110) performs a function of detecting a facial area based on the learning data which the above rectangular feature point model is learned through the AdaBoost learning algorithm;

The above face detection module (110) performs a function of determining the above detected facial area as a valid facial area when the size of the result value of the above AdaBoost exceeds a predetermined threshold value.

On the other hand, the function of determining the above detected facial area as a valid facial area when the size of the result value of the above AdaBoost exceeds a predetermined threshold value among the functions of the above face detection module sets up an additional face validity determination module (120) to work separately from other functions of the above face detection module (110).

The device for generating customer's personal information (1000) in this implementation example has also a facial feature point detection module (130).

The above facial feature point detection module (130) detects facial feature points for the facial areas determined to be valid (or determined to be valid in a validity determination module (120) when there is a face validity determination module (120)) in the above facial feature point detection module (110).

For example, The above facial feature point detection module (130) can detect 28 facial feature points which can be defined at each position around eyebrows, eyes, a nose, and a mouth including the face rotation angle of view.

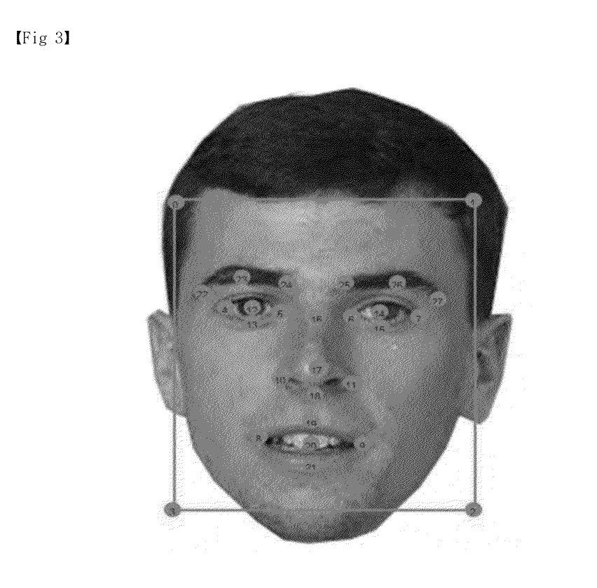

As described in FIG. 3, the feature points defining a facial area (0, 1, 2 and 3), those defining eyes (4, 5, 6, 7, 12, 13, 14 and 15), those defining eyebrows (22, 23, 24, 25, 26 and 27), those defining a nose (10, 11, 16, 17 and 18) and those defining a mouth (8, 9, 20, 21 and 19) can desirably be detected as facial feature points in this implementation example.

The device for generating customer's personal information (1000) in this implementation example has also a gender estimation module (140).

The above gender estimation module (140) performs the following four functions: a function of using the above detected facial area to estimate the above viewer's gender;

The above gender estimation module (140) performs a function of cutting out a facial area for gender estimation in the above detected facial area;

The above gender estimation module (140) performs a function of normalizing the image of the cut facial area;

The above gender estimation module (140) performs a funtion of normalizing histogram

The above gender estimation module (140) performs a function of using a normalized image to estimate a customer's gender with SVM (Support Vector Machine).

A customer's estimated gender information can be stored in a gender database (145).

The device for generating customer's personal information (1000) in this implementation example has also an age estimation module (150).

The above age estimation module (150) estimates the following five functions;

The above age estimation module (150) performs a function of using the above detected facial area to estimate the above viewer's age;

The above age estimation module (150) performs a function of cutting out a facial area for age estimation in the facial areas detected above;

The above age estimation module (150) performs a function of normalizing the image of the cut facial area; a function of correction the local lighting;

The above age estimation module (150) performs a function of setting up an input vector from a normalized image to project them into an age manifold space; and

The above age estimation module (150) performs a function of estimating a customer's age with a quadratic polynomial regression model.

A customer's estimated age information can be stored in an age database (155).

On the other hand, the above gender (140) and the above age estimation module (150) are integrated to set up a personal information generation module (145).

The device for generating customer's personal information (1000) in this implementation example has also a statistics generation module (160).

The above statistics generation module (160) performs a function of generating one between the statistical information related to at least one information of the above customer's gender and age based on the above estimated and generated personal information related to a customer's gender and age and one related to customer's personnel information by time period based on the above generated personal information.

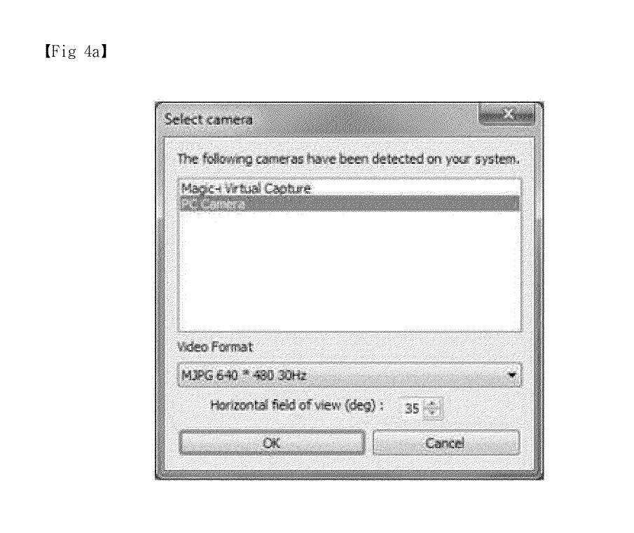

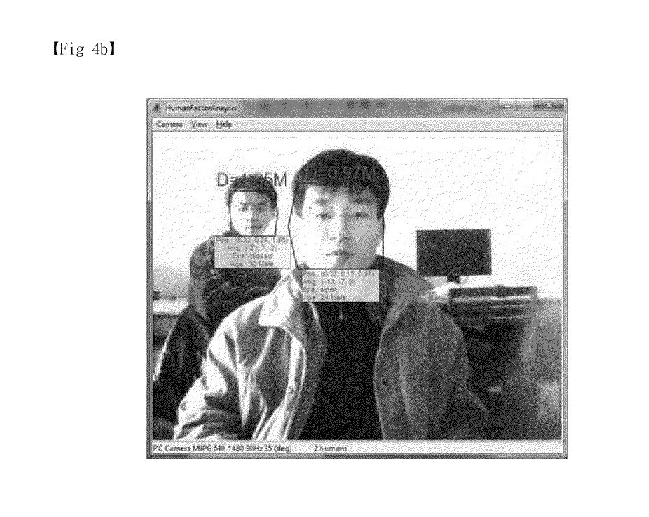

The device for generating customer's personal information (1000) in this implementation example has the user interface module (170) which can set up the image input apparatus (180) installed at the task of the above POS terminal (1) and display the results of the estimated and generated results of age and gender (FIG. 4b).

On the other hand, the above user interface module (170) includes an image capture apparatus (171), a face information viewing apparatus (172), personnel stats viewing apparatus (173), gender stats viewing apparatus (174) and an age stats viewing apparatus (175).

The above image capture apparatus (171) captures images in the images input via an image input apparatus (180).

The above face information (172) can be a display screen which can show the face of the customer detected via the above image input apparatus (180) with graphics.

It can identify the face of the detected customer to check whether or not the estimate gender or age is correct.

The above personnel stats viewing apparatus (173) can identify statistical information related customer's personnel information by time period based on the above generated personal information.

The above gender stats viewing apparatus (174) can identify statistical information based on personal information about the above estimated customer's gender,

for example one based on a customer's gender information such as information about the preference toward a special product by gender.

The above age stats viewing apparatus (175) can identify statistical information based on personal information about the above estimated customer's age,

for example one based on a customer's age information such as information about the preference toward a special product by age.

On the other hand, the device for generating customer's personal information (1000) in this implementation example is equipped with many modules such as a face detection module (110), a face validity determination module (120), a feature point detection module (130), a gender estimation module (140), an age estimation module (150) and a stats generation module (160) and many apparatuses such as an image capture apparatus (171), a face information viewing apparatus (172), a personnel stats viewing apparatus (173), a gender stats viewing apparatus (174) and an age stats viewing apparatus (175) included in an user interface module (170), an image input apparatus (180) and a control module which generally controls a purchasing information input apparatus (190).

On the other hand, drawing code 190 can be designed as a barcode reader as purchasing information input apparatus. It can directly be connected to each server (10 and 20) or through a POS terminal.

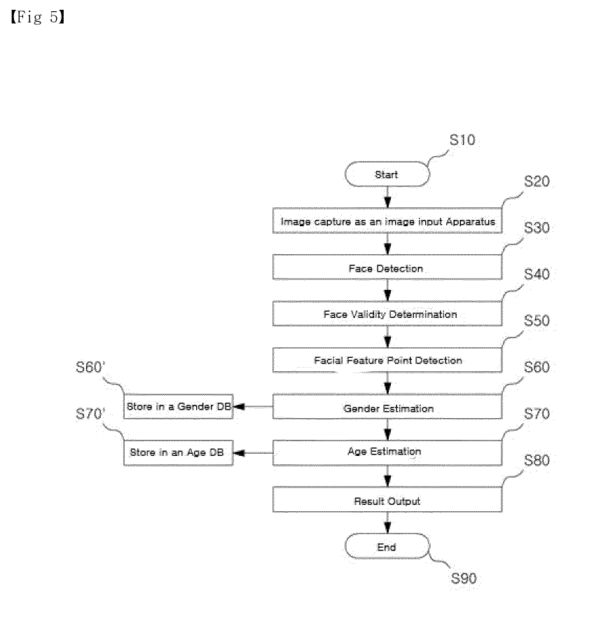

FIG. 5 is a flowchart describing the process of generating customer's personal information in accordance with a task implementation example of this invention.

As described earlier, the method for generating customer's personal information according to this implementation example is composed of 9 stages, namely the beginning stage of the generation process (S10), an image capture stage (S20), the face detection stage (S30), the face validity determination stage (S40), the facial feature point detection stage (S50), the gender estimation stage (S60), the age estimation stage (S70), the result output stage (S80) and the end stage (S90).

On the other hand, the gender information estimated at the gender estimation stage (S60) can be stored in a gender database (S60′), whereas the age information estimated at the age estimation stage (S70) can be stored in an age database (S70′)

At the capture stage (S20), the above image is captured in a customer's image input through the image input apparatus.

For example, the image capture from the image input via the above image input apparatus can be made through the method which captures the image from the image input via an image input apparatus using DirectX Sample Grabber. As a desirable example, the media type of the sample grabber can be set up as RGB24.

On the other hand, when the image format of an image input apparatus is different from RGB24, a video converter filter automatically adheres to the front end of the sample grabber so that the image finally captured on the sample grabber can be RGB24.

For example

AM_MEDIA_TYPE mt;

// Set the media type to Sample Grabber

ZeroMemory (&mt, size of (AM_MEDIA_TYPE));

mt.formattype=FORMAT_VideoInfo;

mt.majortype=MEDIATYPE_Video;

mt.subtype=MEDIASUBTYPE_RGB24; // only accept 24-bit bitmaps

hr=pSampleGrabber->SetMediaType(&mt).

it can be organized like the following equation:

At the above face detection stage (S30), the above customer's facial area is detected from the image extracted from the image input via an image input apparatus installed at the task location of the above POS terminal.

There are many face detection methods such as knowledge-based, feature-based, template-matching and appearance-based methods.

The appearance-based method is desirably used in this implementation example.

It is a method that a facial and a non-facial area is obtained from different images, the obtained area is learned to make a learning model and an input image and learning model data are compared to detect a face.

It is known as a relatively high performance method in frontal and lateral face detection.

This face detection can be understood in many papers such as “Fast Asymmetric Learning for Cascade Face Detection,” (IEEE Tran-saction on Pattern Analysis and Machine Intelligence, Vol. 30, No. 3, MARCH 2008.) written by J. Wu, S. C. Brubaker, M. D. Mullin and J. M. Rehg and “Rapid Object Detection using a Boosted Cascade of Simple Features” (Accepted Conference on Computer Vision and Pattern Recognition 2001.) by P. Viola and M. Jones.

On the other hand, the detection of a facial area in this implementation example is made through the following three stages: (a1) stage where the YCbCr color model is drawn up from the RGB color information of the above extracted image, color and brightness information are separated from the color model drawn up and a face candidate area is detected according to the above brightness information; (a2) stage where the rectangular feature point model about the above detected face candidate area is defined and a facial area is detected based on the learning data which the above rectangular feature point model is learned through the AdaBoost learning algorithm; and (a3) stage where the above detected facial area is determined as a valid facial area when the size of the result value of the above AdaBoost (CF_{H}(x) in [Equation 1] described below) exceeds a predetermined threshold value.

$$C {F}_{H} ( x ) = {\sum }_{m = 1}^{M} {h}_{m} ( x ) - θ \qquad [ Equation 1 ]$$

(But, M: the total number of weak classifiers composed of the strong classifier

hₘ(x): the output value in the m^{th} weak classifier

θ: empirically set up as the value used to control the error rate of the strong classifier more minutely)

Adaboost learning algorithm is known as the algorithm which finally generates a strong classifier with high detection performance through the linear combination of a weak classifier.

In this implementation example, not only the existing symmetric Haar-like features but also the asymmetric features of a non-frontal face are included to improve the detection performance in a non-frontal face.

The unique structural features of the face such as eyes, nose and mouth are symmetric because they are evenly distributed all over the frontal face image.

On the other hand, as the structural features of the face are not symmetric and concentrated within a narrow range, and the contour of the face is not a straight line in a non-frontal face image, many background areas are mixed.

Therefore, the new Haar-like features which are similar with the existing Haar-like features and the asymmetry is added are included in this implementation example to overcome the problem that the high detection performance about a non-frontal face can be not obtained with the existing symmetric Haar-like features.

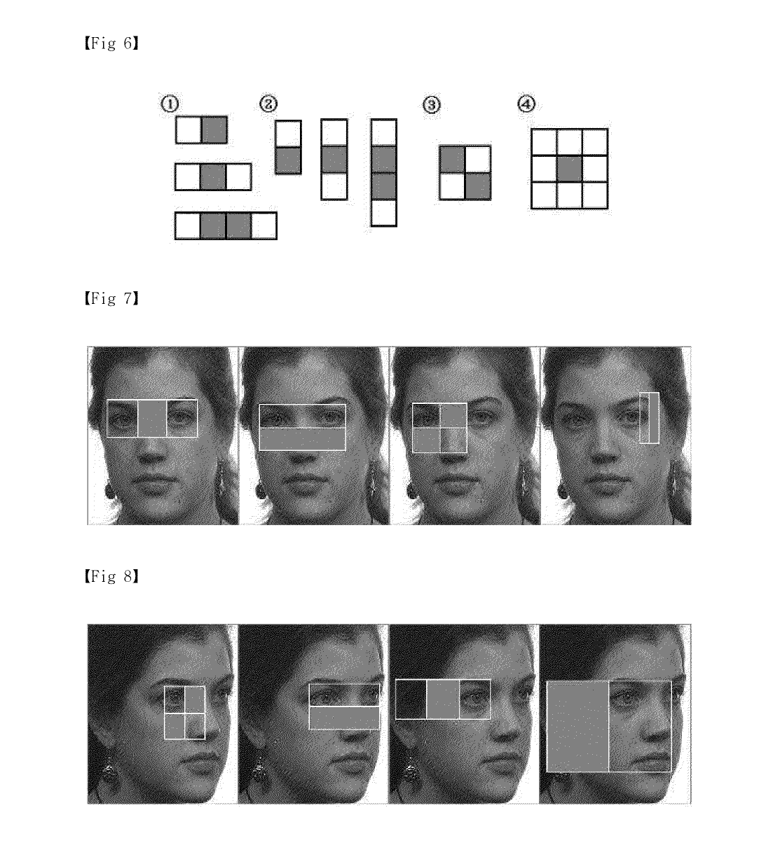

In this regard, FIG. 6 shows the basic forms of the existing Haar-like features. While FIG. 7 is the exemplary picture of the Haar-like features selected to detect a customer's frontal face information according to a task implementation example of this invention, FIG. 8 is the exemplary picture of the Haar-like features selected to detect a customer's non-frontal face.

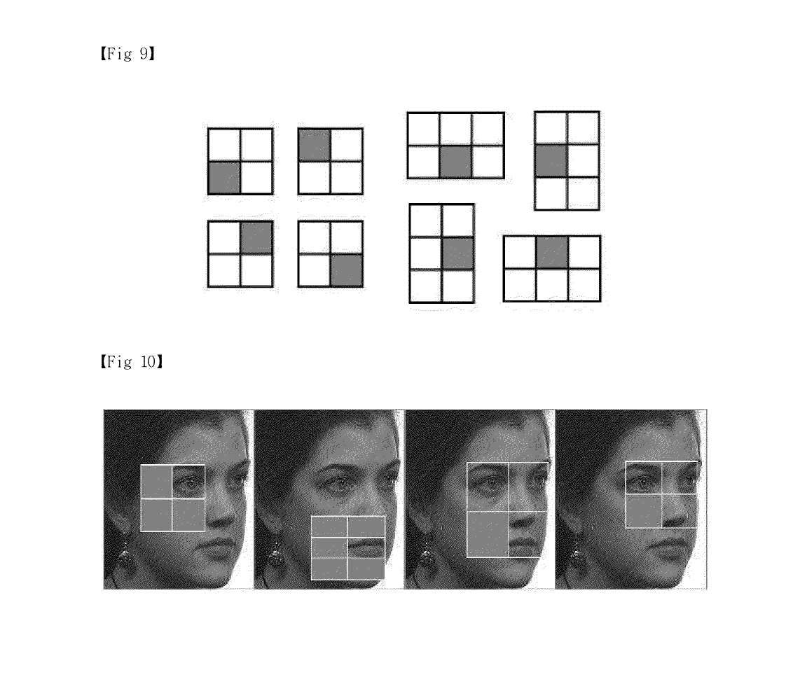

FIG. 9 shows the rectangular features newly added according to this implementation example. FIG. 10 presents the examples of the Haar-like features selected from the Haar-like features in FIG. 9 to detect a customer's non-frontal face.

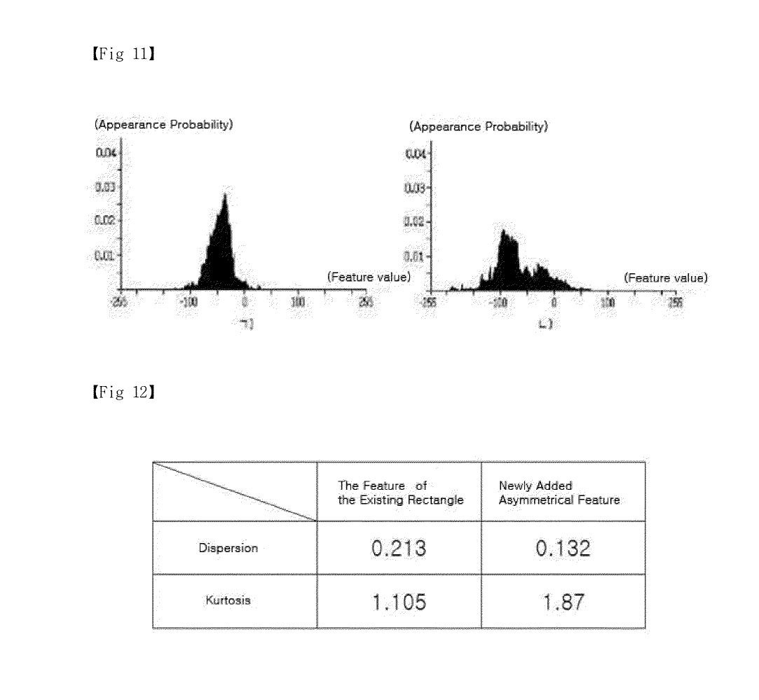

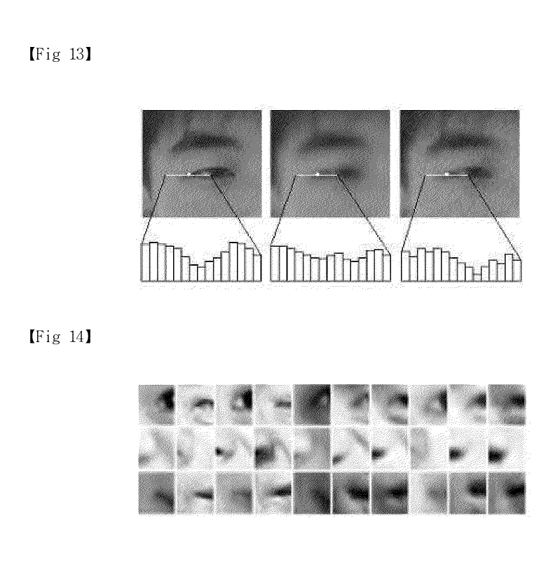

As described in FIG. 12, Haar-Like features in this implementation example are composed of asymmetric forms, structures, and shapes differently from the existing symmetric Haar-like features. Therefore, they can reflect the structural features of a non-frontal face well and have excellent detection effects in non-frontal face images.

FIG. 11 shows a Haar-like feature probability curve in the training set about the existing Haar-like features and the Haar-like features applied to this implementation example.

While A) corresponds to this implementation example, B) represents the existing case. As described earlier, the probability curves corresponding to this implementation example are concentrated within a much narrower range. According to the base classification rule,

it means that the Haar-like features added in this implementation example are effective in non-frontal face detection.

FIG. 12 is a table describing the features newly added from the training set of a non-frontal face,

the dispersion of the probability curve of the existing Haar-like feature and the average value of Kurtosis.

It is known that the Haar-like features added in this implementation example are effective in detection because they have small dispersion and high Kurtosis.

As stated above, the Haar-like features for the detection of the above facial area include the asymmetric Haar-like features for the detection of non-frontal facial areas at the above (a2) stage.

On the other hand, there are many methods of determining face validity such as PCA (principle component analysis) or neural network methods. These methods have the disadvantages that they are slow and require separate interpretations.

Therefore, the size of the result value of the above AdaBoost (CF_{H}(x) in [Equation 1] described below) and a predetermined threshold value are compared to determine the validity of the detected face in a task implementation example of this invention.

Even though only the code value is used in the existing AdaBoost method as shown in [Referential Formula 1] described below, its actual size is used to determine face validity in this implementation example.

$$H ( x ) = sign [ {\sum }_{m = 1}^{M} {h}_{m} ( x ) - θ ] \qquad [ Referential Formula 1 ]$$

In other words, the size of CF_{H}(x) can be used as an important element needed to determine face validity in the above [Equation 1].

As this value (CF_{H}(x)) becomes a criterion showing how much the detected area approximates the face, a predetermined threshold value is set up to be used to determine face validity.

At this time, a predetermined threshold value is empirically set up with a learning face meeting.

At the facial feature point detection stage (S50), facial feature points are detected in the above detected facial area.

At the above facial feature point detection stage (S200), the Adaboost algorithm is used to detect facial feature points even though feature points are searched with the ASM (active shape model).

For example, the detection of the above facial feature point is made through the following three stages: (b1) stage where the location of the present feature point is defined to be (x₁, y₁) and the partial windows with the non pixel size are classified with a classifier around the location of the present feature point; (b2) stage where the candidate location of the feature point is calculated according to [Equation 2] described below; (b3) stage where (x′₁, y′₁) is determined as a new feature point when the condition of [Equation 3] described below is met, but the present feature point, (x₁, y₁), is otherwise maintained.

$$\begin{matrix}{x}_{l}^{′} = \frac{{\sum }_{dy = - b}^{b} {\sum }_{dx = - a}^{a} ( {x}_{l} + d x ) ( C {F}_{1 \text{:} {N}_{pass}} \cdot ( {x}_{dx , dy} ) \cdot {c}^{{N}_{all} - {N}_{pass}} )}{{\sum }_{dy = - b}^{b} {\sum }_{dx = - a}^{a} ( C {F}_{1 \text{:} {N}_{pass}} \cdot ( {x}_{dx , dy} ) \cdot {c}^{{N}_{all} - {N}_{pass}} )} \\ {y}_{l}^{′} = \frac{{\sum }_{dy = - b}^{b} {\sum }_{dx = - a}^{a} ( {y}_{l} + d y ) ( C {F}_{1 \text{:} {N}_{pass}} \cdot ( {x}_{dx , dy} ) \cdot {c}^{{N}_{all} - {N}_{pass}} )}{{\sum }_{dy = - b}^{b} {\sum }_{dx = - a}^{a} ( C {F}_{1 \text{:} {N}_{pass}} \cdot ( {x}_{dx , dy} ) \cdot {c}^{{N}_{all} - {N}_{pass}} )} & [ Equation 2 ] \\ {\sum }_{dy = - b}^{b} {\sum }_{dx = - a}^{a} ( C {F}_{1 \text{:} {N}_{pass}} \cdot ( {x}_{dx , dy} ) \cdot {c}^{{N}_{all} - {N}_{pass}} ) > {T}_{c f} & [ Equation 3 ]\end{matrix}$$

(But, a: the nearest neighbor distance exploring into the direction of the x-axis

b: the nearest neighbor distance exploring into the direction of the y-axis

x_{dx,dy}: the partial window with the point (dx, dy) which is away from (x₁, y₁) as the center

Nₐₗₗ: the total number of stairs in the classifier

Nₚₐₛₛ: the number of the stairs that a partial window is passed through

C: the number of the stairs that a partial window is passed through C: the constant value smaller than 1, which is obtained through a test to limit the reliability value of the partial window which is not passed through to the last)

There are several methods for facial feature point detection such as a method of detecting feature points individually or at the same time in the correlation between feature points.

As for a method of detecting feature points individually, there is a problem that many detection errors occur in facial images. Accordingly, an active shape model (ASM), a desirable method for facial feature detection in relation to speed and accuracy is used in this implementation example.

This ASM method can be understood in many papers such as “Active shape models: Their training and application” (CVGIP: Image Understanding, Vol. 61, pp. 38-59, 1995) written by T. F. Cootes, C. J. Taylor, D. H. Cooper and J. Graham, “Texture-constrained active shape models” (In Proceedings of the First International Workshop on Generative-Model-Based Vision (with ECCV), May 2002) by S. C. Yan, C. Liu, S. Z. Li, L. Zhu, H. J. Zhang, H. Shum and Q. Cheng, “Active appearance models” (In ECCV 98, Vol. 2, pp. 484-498, 1998) by T. F. Cootes, G. J. Edwards and C. J. Taylor, and “Comparing Active Shape Models with Active Appearance Models” (In ECCV 98, Vol. 2, pp. 484-498, 1998) by T. F. Cootes, G. J. Edwards and C. J. Taylor.

On the other hand, as the search for feature points with the existing ASM is made with profiles, the detection can stably be made in only high-quality images.

In general, the image extracted from the image via an image input apparatus such as a camera can be obtained as a low resolution and low quality image. In this implementation example, this problem is improved by the use of an AdaBoost method so that feature points can easily be detected in low resolution and low quality images.

FIG. 13 is the profile picture applied to the existing ASM method for a low resolution or poor quality image. On the other hand, FIG. 14 is the pattern picture around each landmark used in AdaBoost to search the landmarks of this invention.

As described in FIG. 3, 28 facial feature points which can be defined at each position around eyebrows, eyes, a nose, and a mouth can be detected at the above facial feature point detection stage (S50) and estimation information generation stage (S400).

To be specific, the feature points defining a facial area (0, 1, 2 and 3), those defining eyes (4, 5, 6, 7, 12, 13, 14 and 15), those defining eyebrows (22, 23, 24, 25, 26 and 27), those defining a nose (10, 11, 16, 17 and 18) and those defining a mouth (8, 9, 20, 21 and 19) can be detected as facial feature points.

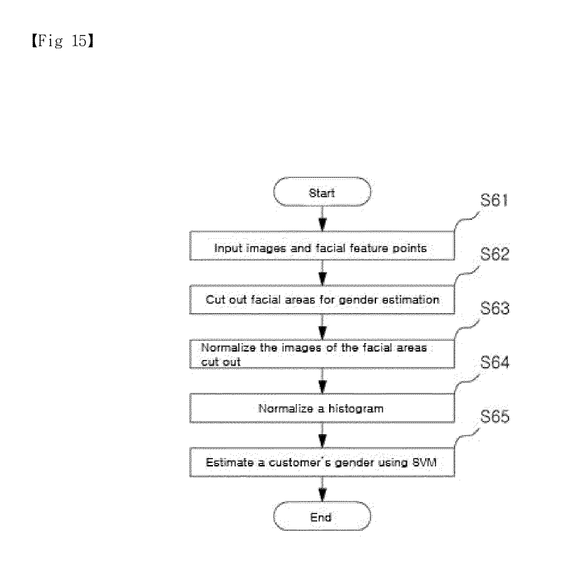

As described in FIG. 15, the gender estimation stage (S60) is composed of five processes, namely the input of images and facial feature points (S61), the cut of facial areas for gender estimation (S62), the normalization of the images in the cut facial areas (S63), histogram normalization (S64) and gender estimation with the SVW (S65).

There are several gender estimation methods such as the viewing-based method of using all the facial features and the geometric feature-based method of using only geometric facial features.

As a desirable example, the above gender estimation is made with a viewing-based gender classification method using a support vector machine (SVM), which is the process that the detected facial areas are normalized to set up facial feature vectors and predict the gender.

The SVM method can be divided into two types, SVC (Support Vector Classifier) and SVR (Support Vector Regression).

The above gender estimation can be understood through many papers such as “Boosting Sex Identification Performance” (Carnegie Mellon University, Computer Science Department. 2005) written by S. Baluja & et al, “Gender and ethnic classification” (IEEE Int. Workshop on Automatic Face and Gesture Recognition, pages 194-199.1998) by Gutta & et al and “Learning Gender with Support Faces” (IEEE T. PAMI Vol. 24, No. 5. 2002) by Moghaddam & et al.

In this implementation example, the gender estimation stage (S60) is concretely divided into following four stages: (c-a1) stage where a facial area is cut out for gender estimation in the facial area detected above based on the facial feature point detected above; (c-a2) stage where the size of the above facial area cut out for gender estimation is normalized; (c-a3) stage where the histogram in the facial area that the above size is normalized for gender estimation is normalized; and (c-a4) stage where an input vector is set up from the facial area that the above size and the above histogram are normalized for gender estimation and the SVW algorithm previously learned is used to estimate a customer's gender.

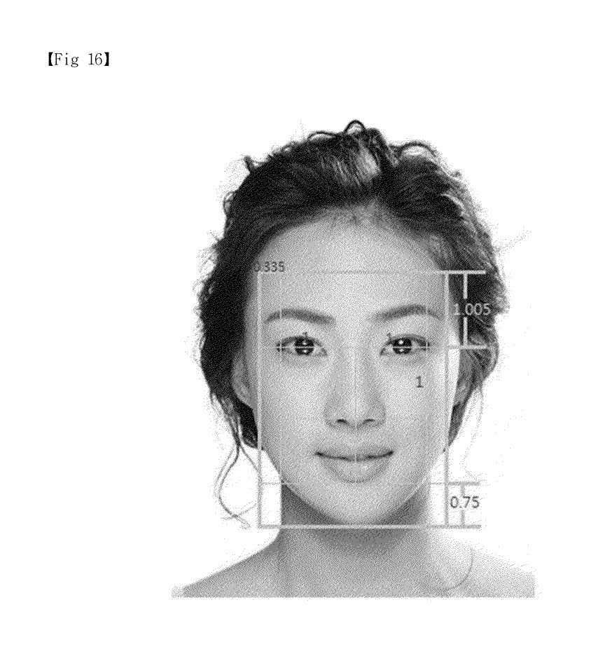

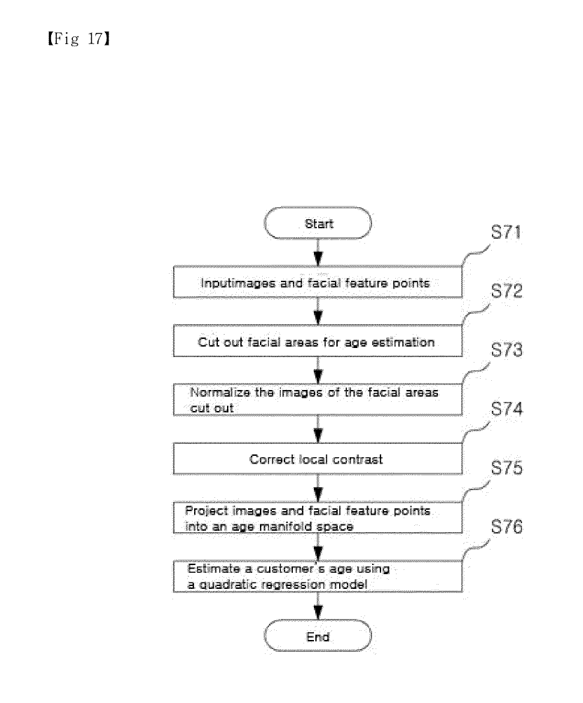

At the above (c-a1) stage, input images and facial feature points are used to cut facial areas. For example, the facial area to be cut out is calculated after half the distance between the left and the right corner of the eye is considered 1 as described in FIG. 16.

At the above (e2) stage, the cut facial area is normalized to be the 12×21 size.

At the above (e3) stage, a histogram normalization, the process of matching a histogram with the number of the pixels which have every concentration value to minimize the influence of lighting effect.

At the above (e4) stage, a 252-dimensional input vector is set up from the 12×21 normalized face image and the gender is estimated with the SVM previously learned.

At this time, a customer is determined as a man when the calculation result value of the classifier in [Equation 4] described below is greater than 0. Otherwise, a customer is determined as a woman.

$$f ( x ) = {\sum }_{i = 1}^{M} {y}_{i} {α}_{i} \cdot k ( x , {x}_{i} ) + b \qquad [ Equation 4 ]$$

(But, M: the number of sample data,

yᵢ: the gender value of the i-th test data. It is set up to determine as a man when yᵢ is 1 and a woman when yᵢ is −1.

αᵢ: the coefficient of the i-th vector,

x: test data,

xᵢ: learning sample data,

k: Kernel function,

b: deviation)

At this time, the Gaussian radial basis function (GRBF) defined in [Equation 5] described below can be used as the above Kernel function.

$$k ( x , {x}^{′} ) = exp ( - \frac{{‖ x - {x}^{′} ‖}^{2}}{2 {σ}^{2}} ) \qquad [ Equation 5 ]$$

(But, x: test data, x′: learning sample data, σ: Variable representing the degree of dispersion)

On the other hand, the polynomial kernel can be used as a kernel function in addition to the Gaussian radial basis function (GRBF). The Gaussian radial basis function (GRBF) is used considering its identification performance.

On the other hand, the support vector machine method (SVM) is known as a learning algorithm for pattern classification and regression as a classification method drawing the boundary of two groups in a meeting with two groups.

The basic learning principle of SVMs is to find the optimal linear hyper plane with good generalization performance, which predicted classification errors for invisible test samples are minimized.

The classification method of finding the linear function with a minimum order is used on the basis of this principle in the linear SVM.

The learning problem of the SVM comes down to a two-dimensional planning problem with linear constraints.

After a learning sample and each class label are respectively regarded as x1, . . . , xi, and y1, . . . , yi, it is set up that y=1 when a learning sample is a man and y−−1 when it is a woman.

The constraint of [Referential Formula 2] describe below is given to determine learning results randomly.

$${min}_{i = 1 , … , 1} \vert {ω}^{T} {x}_{i} + b \vert = 1 \qquad [ Referential Formula 2 ]$$

The minimum distance between a learning sample and a hyper plane becomes certainly like in [Referential Formula 4] described below because it is expressed in [Referential Formula 3] described below when this constraint is given.

$$\begin{matrix}{min}_{i = 1 , … , 1} \frac{\vert {ω}^{T} {x}_{i} + b \vert}{‖ ω ‖} & [ Referential Formula 2 ] \\ \frac{1}{‖ ω ‖} & [ Referential Formula 4 ]\end{matrix}$$

W and b are formulated as shown in [Referential Formula 5] described below because they are determined to maximize the minimum distance while fully identifying a learning sample.

Target function: ∥ω∥²→Minimization

Constraint: yᵢ(ω^{T}Xᵢ+b)≧1 (i=1, . . . , 1) [Referential Formula 5]

The minimization of a target function is to maximize the value of [Equation 4] described above, the minimum distance.

Therefore, the support vector which maximizes the above target function, w and a deviation, b is calculated.

The optimal constant, is [symbol] determined as shown in [Referential Formula 6] described below in the SVM using the kernel.

$${α}^{*} = arg {min}_{α} \frac{1}{2} {\sum }_{i = 1}^{l} {\sum }_{j = 1}^{l} {α}_{i} {α}_{j} {y}_{i} {y}_{j} K ( {x}_{i} , {x}_{j} ) - {\sum }_{k = 1}^{l} {α}_{k} \qquad [ Referential Formula 6 ]$$

At this time, the constraint equates to [Referential Formula 7] described below.

$$0 \leq {α}_{i} \leq C i = 1 , … , l \\ {\sum }_{j = 1}^{l} {α}_{j} {y}_{j} = 0. \qquad [ Referential Formula 7 ]$$

Here, K(x, x′) is a non-linear kernel function.

The deviation is calculated as shown in [Referential Formula 8] described below.

$${b}^{*} = - \frac{1}{2} {\sum }_{i = 1}^{l} {α}_{i} {y}_{i} [ K ( {x}_{i} , {x}_{r} ) + K ( {x}_{i} , {x}_{r} ) ] \qquad [ Referential Formula 8 ]$$

A viewer is determined as a man when the calculation result value of the classifier in [Equation 3] described below, which is obtained by the same method described above is 1 and as a woman when it is 0.

Meanwhile, even though the AdaBoost method can be used in the above process, it is very desirable to use the SVM method when the performance and the generalization performance of a classifier are considered.

For example, when gender estimation performance is tested for Europeans after the faces of Asians are learned by the AdaBoost method, about 10˜15% performance lowered in comparison with the case that they are tested by the SVM method.

There is an advantage that high identification capability can be obtained when gender estimation is made with the SVM method under the condition that learning data is not sufficiently given.

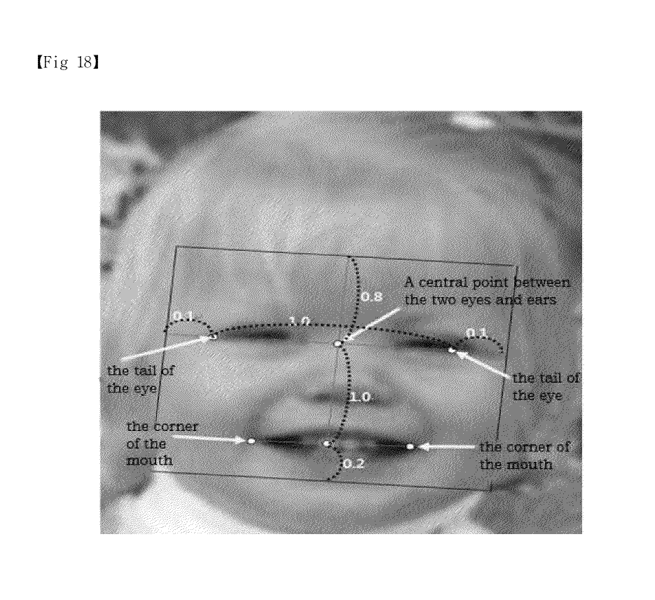

As described in FIG. 17, the above age estimation stage (S70) is composed of six processes, namely the input of images and facial feature points (S71), the cut of facial areas for age estimation (S72), the normalization of the images in the cut facial area (S73), the correction of the local lighting (S74), the projection into an age manifold space (S75) and age estimation with a quadratic polynomial regression model (S76).

The age estimation method can be understood in many papers such as “Estimating human ages by manifold analysis of face pictures and regression on aging features” (Proc. IEEEConf. Multimedia Expo., 2007, pp. 1383-1386) written by Y. Fu, Y. Xu and T. S. Huang, “Locally adjusted robust regression for human age estimation” presented by Y. Fu, T. S. Huang and C. Dyer at the IEEEWorkshop on Applications of Computer Vision in 2008, “Comparing different classifiers for automatic age estimation” (IEEE Trans. Syst., Man, Cybern. B, Cybern., vol. 34, no. 1, pp. 621-628, February 2004) by A. Lanitis, C. Draganova, and C. Christodoulou.

In this implementation example, the age estimation is concretely made through the following five stages: (c-b1) stage where a facial area is cut out for age estimation in the facial area detected above based on the facial feature point detected above; (c-b2) stage where the size of the facial area cut out for age estimation is normalized; (c-b3) stage where the local lighting of the facial area that the above size is normalized for age estimation is corrected; (c-b4) stage where an input vector is set up from the facial area that the above size is normalized and the local lighting is corrected for age estimation and projected into an age manifold space to generate a feature vector; and (c-b5) stage where a quadratic regression is applied to the feature vector generated above to estimate a customer's age.

At the above (c-b1) stage, a facial area is cut out using input images and facial feature points.

For example, a facial area is cut out after the lengths are respectively extended to the top (0.8), the bottom (0.2), the left (0.1) and the right (0.1) from the outer corners of both eyes and the corners of the mouth as described in FIG. 18.

At the above (c-b2) stage, the cut facial areas are normalized to be the 64×64 size.

At the above (c-b3) stage, the local lighting is corrected by [Equation 6] describe below to reduce the influence of lighting effects.

I(x,y)=(I(x,y)−M)/V*10+127 [Equation 6]

(But, I(x, y): gradation value at the (x, y) position, M: average gradation value at the 4×4 partial window area, V: standard variance value)

The above standard variance value (V) is the feature value representing the degree that the value of a coincidence disperses around the average value and mathematically calculated as shown in [Referential Formula 9] described below.

V={square root over (Σ_{x,y}(I(x,y)−M)²)} [Referential Formula 9]

At the above (c-b4) stage, a 50 dimensional feature vector is generated after a 4096-dimensional input vector is set up from the 64×64 face image and projected into the age manifold space previously learned.

According to the theory of age estimation, it is assumed that the features showing the human aging process reflected in facial image can be expressed the patterns in accordance with a certain low-level distribution.

The low-level feature space at this time is called an age manifold space. It is fundamental to estimate the projection matrix into an age manifold space from the facial image for age estimation.

The learning algorithm of the projection matrix into an age manifold space by the conformal embedding analysis (CEA) will briefly be explained.

Y=P^{T}X [Referential Formula 10]

In [Referential Formula 10] described above, X, Y and P respectively represent an input vector, a feature vector, and a projection matrix into an age manifold space, which has previously been learned with a CEA.

The relevant content can be understood in “Human Age Estimation with Regression on Discriminative Aging Manifold in Multimedia’ (IEEE Transactions on, 2008, pp. 578-584”), a paper written by F. Yun and T. S. Huang.

The n number of facial images, x₁, x₂, . . . , xₙ is expressed as X={x₁, . . . , xₙ}εR^{m}.

At this time, X and xᵢ respectively show a m×n matrix and every facial image

At the manifold learning stage, it is supposed to get the projection matrix needed to express a m-dimensional face vector (aging feature vector) which a d-dimensional face vector is d<<m (d is much smaller than m).

In other words, it is to get the projection matrix which is yᵢ=Pₘₐₜ×xᵢ, Pₘₐₜ, It is {y₁, . . . , yₙ}εR^{d} and d is set up as 50 here.

In general, the m order of images is much larger than the n number of images when a face interpretation is made.

Therefore, the m×m matrix, XX^{T} is a degeneration matrix. A facial image is first projected into the partial space with no information loss using a PCA and the resulting matrix, XX^{T}, becomes a non-degenerate matrix to solve this problem.

(1) PCA Projection

If the n number of face vectors is given, the covariance matrix related to this face vector meeting, C_{pca}, are obtained.

C_{pca} is the m×m matrix.

The problem of eigenvalues and eigenvectors, C_{pca}×Eigen_{vector}=Eigenᵥₐₗᵤₑ×Eigen_{vector} about the covariance matrix, C_{pca} are solved to get the n number of eigenvalues and the m number of m-dimensional eigenvectors. The d number of eigenvectors is selected in order of the larger values to organize a matrix, W_{PCA}.

W_{PCA} is the m×d matrix.

(2) Setup of Weight Matrices, Ws and Wd

Ws shows the relationship among the facial images belonging to the same age group, whereas Wd represents one to the different group.

$$\begin{matrix} [ Referential Formula 11 ] & \\ {W}_{ij} = \{ \begin{matrix}exp ( \frac{- Dist ( {x}_{i} , {x}_{j} )}{t} ) , & When Xi and Xj are related \\ 0 , & When Xi and Xj are not related\end{matrix} & \end{matrix}$$

Dist (Xᵢ, Xⱼ) in the [Referential Formula 11] described above equates to [Referential Formula 12] described below.

$$Dist ( {x}_{i} , {x}_{j} ) = 1 - \frac{[ {x}_{i} - Mean ( {x}_{i} ) ] \cdot [ {x}_{j} - Mean ( {x}_{j} ) ]}{‖ {x}_{i} - Mean ( {x}_{i} ) ‖ ‖ {x}_{j} - Mean ( {x}_{j} ) ‖} \qquad [ Referential Formula 12 ]$$

(3) Calculation of the Basis Vector of a CEA

An engenvector equivalent to the largest engenvalue of the d number of [\tilde{X}(Ds−Ws)\tilde{X}^{T}]⁻¹\tilde{X}(Dd−Wd)\tilde{X}^{T} becomes the basis vector of CEA.

$${D}_{d} [ i , i ] = {\sum }_{j} {w}_{ij}^{( d )} , {D}_{s} [ i , i ] = {\sum }_{j} {w}_{ij}^{( s )} \\ \tilde{X} = [ {\tilde{x}}_{1} {\tilde{x}}_{2} … {\tilde{x}}_{n} ] ∈ {R}^{D \times n} ( {\tilde{x}}_{i} = ( {x}_{i} - \frac{Mean ( {x}_{i} )}{‖ {x}_{i} - Mean ( {x}_{i} ) ‖} \qquad [ Referential Formula 13 ]$$

(4) CEA Concealment

When orthonormal basic vectors, a₁, . . . , a_{d}, are calculated, a matrix, WCEA is defined as shown in 14 [Referential Formula 14 described below.

W_{CEA=[}a₁, . . . , a_{d]} [Referential Formula 14]

W_{CEA} is a m×d matrix in [Referential Formula 14].

At this time, the projection matrix, Pₘₐₜ, is defined as shown in [Referential Formula 15] described below.

Pₘₐₜ=W_{PCA}W_{CEA} [Referential Formula 15]

x The amount of aging features about every face vector, X, is obtained with a projection matrix, Pₘₐₜ.

→y=Pₘₐₜ^{T}×x [Referential Formula 16]

(But, y is a d-dimensional vector equivalent to a face vector, X, namely the amount of aging features.)

At the above (f5) stage, the above quadratic regression is applied to estimate the age in [Equation 11] described below.

L=b₀+b₁^{T}Y+b₂^{T}Y² [Equation 7]

(But, b₀, b₁, b₂: the regression coefficients previously calculated from learning data

Y: the aging feature vector calculated from Test data x in [Referential Formula 16],

L: estimated age)

b₀, b₁ and b₂ are calculated in advance from learning data as follows:

A quadratic regression model equates to [Referential Formula 17] described below.

\hat{l}ᵢ=\hat{b}₀+\hat{b}₁^{T}yᵢ+\hat{b}₂^{T}yᵢ² [Referential Formula 17]

\hat{l}ᵢ is the age of the i^{th} learning image, whereas yᵢ is the feature vector of the i^{th} learning image.

This is expressed in the vector-matrix form as shown in [Referential Formula 18] described below.

\hat{L}=\tilde{Y}\hat{B} [Referential Formula 18]

[symbol] ,

\hat{L}=[\hat{l}₁ . . . \hat{l}ₙ]^{T}, \hat{B}=[\hat{b}₀\hat{b}₁⁽¹⁾ . . . \hat{b}₁^{(d)}\hat{b}₂⁽¹⁾ . . . \hat{b}₂^{(d)}]^{T}

\tilde{Y}=[1_{n×1}[y₁ . . . yₙ]^{T}[y₁² . . . yₙ²]^{T}], [Referential

Here, n is the number of learning data.

At this time, the regression constant, \hat{B}, is calculated as shown in [Referential Formula 20] described below.

\hat{B}=(\tilde{Y}/\tilde{Y})⁻¹\tilde{Y}/L [Referential Formula 20]

At the above result output stage (S80), a customer's gender information estimated in the same process described earlier is printed out with a gender DB to be stored, while a customer's gender information is printed out with an age DB to be stored.

As stated earlier, the estimated gender and age information are printed out with a statistics generation module so that the statistics can be generated in real time.

The implementation examples of this invention include a computer-readable recording medium which contains program commands needed to perform the actions realized by many different computers.

The above computer-readable recording medium can include program commands, data files, data structures and others individually or in combination.

The above recording medium can specially be designed or organized for this invention or announced to those skilled in computer software to be available.

There are magnetic media such as hard disks, floppy disks and magnetic tapes, optical recording media such as CD-ROM and DVD, magnetic-optical media such as floptical disks and the hardware devices specially organized so that program commands can be stored and implemented such as ROM, RAM and flash memory as the examples of a computer-readable recording medium.

The above recording medium can be a transmission medium such as an optical or metallic lines and wave guides, which include a carrier wave transmitting signals which designate program commands and data structures.

There are not only machine codes equal to the things made by compilers but also high-level language codes which can be carried out by a computer using interpreters as the examples of program commands

Even though this invention is described on the basis of desirable implementation examples in reference to the attached floor plan, it is clear that many different types of transformations can obviously be made without departing from the scope of this invention from this statement. Therefore, the scope of this invention shall be interpreted according to the scope of patent claims described to include many transformation examples.

1. A method for generating customer's personal information for a POS system composed of all POS terminals or a network server, the method is characterized to be composed by the following three stage approach: (a) stage where the above customer's facial area is detected from the image extracted from the image input via an image input apparatus installed at the task location of the above POS terminal; (b) stage where a facial feature points are detected from the facial area extracted above; and (c) stage where at least one of the information related to the above customer's gender and age is estimated based on the facial area and the facial feature point extracted above to generate personal information, wherein the (a) stage is related to the method for generating a customer's face tracking information, which is characterized by the following two stage approach:
an (a1) stage where the YCbCr color model is drawn up from the RGB color information of the above extracted image, color and brightness information are separated from the color model drawn up and a face candidate area is detected according to the above brightness information; and
an (a2) stage where the rectangular feature point model about the above detected face candidate area is defined and a facial area is detected based on the learning data which the above rectangular feature point model is learned through the AdaBoost learning algorithm.

2. (canceled)

3. The method according to claim 1 for generating customer's personal information further comprising an (a3) stage where the above detected facial area is determined as a valid facial area when the size of a result value of the above AdaBoost learning algorithm exceeds a predetermined threshold, wherein the AdaBoost learning algorithm comprises:
$$C {F}_{H} ( x ) = {\sum }_{m = 1}^{M} {h}_{m} ( x ) - θ$$
wherein M: the total number of weak classifiers composed of the strong classifier hₘ(x): the output value in the m^{th} weak classifier θ: empirically set up as the value used to control the error rate of the strong classifier more minutely.

4. The method according to claim 1 wherein the Haar-like features for the detection of the above facial area at the above (a2) stage is the method for generating a customer's face tracking information, which is characterized by the addition of asymmetric Haar-like features for the detection of non-frontal facial areas.

5. The method according to claim 1 wherein the (b) stage is related to the method for generating customer's personal information, which is characterized by the point that the Adaboost algorithm is used for its progress even though the landmark is searched with the ASM (active shape model).

6. The method according to claim 5 wherein the detection of the above facial feature point is made with the method for generating a customer's face tracking information, which is characterized by the following three stage approach:
(b1) stage where the location of the present feature point is defined to be (x1, y1) and the partial windows with the n*n pixel size are classified with a classifier around the location of the present feature point;
(b2) stage where the candidate location of the feature point is calculated according to [Equation 2]; and
(b3) stage where (x′1, y′1) is determined as a new feature point when the condition of [Equation 3] is met, but the present feature point, (x1, y1), is otherwise maintained, wherein the [Equation 2] comprises:
$${x}_{l}^{′} = \frac{{\sum }_{dy = - b}^{b} {\sum }_{dx = - a}^{a} ( {x}_{l} + d x ) ( C {F}_{1 \text{:} {N}_{pass}} \cdot ( {x}_{dx , dy} ) \cdot {c}^{{N}_{all} - {N}_{pass}} )}{{\sum }_{dy = - b}^{b} {\sum }_{dx = - a}^{a} ( C {F}_{1 \text{:} {N}_{pass}} \cdot ( {x}_{dx , dy} ) \cdot {c}^{{N}_{all} - {N}_{pass}} )}$$
$${y}_{l}^{′} = \frac{{\sum }_{dy = - b}^{b} {\sum }_{dx = - a}^{a} ( {y}_{l} + d y ) ( C {F}_{1 \text{:} {N}_{pass}} \cdot ( {x}_{dx , dy} ) \cdot {c}^{{N}_{all} - {N}_{pass}} )}{{\sum }_{dy = - b}^{b} {\sum }_{dx = - a}^{a} ( C {F}_{1 \text{:} {N}_{pass}} \cdot ( {x}_{dx , dy} ) \cdot {c}^{{N}_{all} - {N}_{pass}} )} ;$$
and wherein [Equation 3] comprises:
$${\sum }_{dy = - b}^{b} {\sum }_{dx = - a}^{a} ( C {F}_{1 \text{:} {N}_{pass}} \cdot ( {x}_{dx , dy} ) \cdot {c}^{{N}_{all} - {N}_{pass}} ) > {T}_{c f}$$
wherein the nearest neighbor distance exploring into the direction of the x-axis b: the nearest neighbor distance exploring into the direction of the y-axis X_{dx, dy}: the partial window with the point (dx, dy) which is away from (x₁, y₁) as the center Nₐₗₗ: the total number of stairs in the classifier Nₚₐₛₛ: the number of the stairs that a partial window is passed through
C: the constant value to limit the reliability value of the partial window which is not passed through to the last).

7. The method according to claim 1 wherein the above gender estimation at the above (c) stage is related to the method for generating a customer's face tracking information, which is characterized by the following four stage approach:
(c-a1) stage where a facial area is cut out for gender estimation in the facial area detected above based on the facial feature point detected above;
(c-a2) stage where the size of the above facial area cut out for gender estimation is normalized; and
(c-a3) stage where the histogram in the facial area that the above size is normalized for gender estimation is normalized; and (c-a4) stage where an input vector is set up from the facial area that the above size and the above histogram are normalized for gender estimation and the SVW algorithm previously learned is used to estimate a customer's gender.

8. The method according to claim 1 wherein the above age estimation at the above (c) stage is made with the method for generating a customer's face tracking information, which is characterized by a five stage approach comprising:
a (c-b1) stage where a facial area is cut out for age estimation in the facial area detected above based on the facial feature point detected above;
a (c-b2) stage where the size of the facial area cut out for age estimation is normalized;
a (c-b3) stage where the local lighting of the facial area that the above size is normalized for age estimation is corrected; (c-b4) stage where an input vector is set up from the facial area that the above size is normalized and the local lighting is corrected for age estimation and projected into an age manifold space to generate a feature vector; and
a (c-b5) stage where a quadratic regression is applied to the feature vector generated above to estimate a customer's age.

9. The method according to claim 1 wherein generating customer personal information further comprises a (d) stage where at least more than two information of each customer's gender, age, purchasing time and product are correlated to generate statistical information is added after the above (c) stage.

10. The method according to claim 9 wherein generating customer personal information recognizing the above information about purchasing time or product from the above POS terminal.

11. (canceled)

12. The method according to claim 10 wherein the POS system using the method for generating customer's personal information.

13. The method according to claim 12 wherein the POS system characterized by the point that the above POS terminal and the local management server connected to the above POS terminal are added to the device.

14. The method according to claim 12 wherein the above POS terminals are installed at the plural chain points and the central operating server connected to the above POS terminal through an internet.

15. The method according to claim 12 wherein It is the POS system characterized by the point that the above POS terminals installed at the plural chain points, a local operating server, and the central operating server connected to the above POS terminal or the above local operating server through an internet are added to the device.

16. A method for generating customer's personal information for a POS system composed of POS terminals and all the servers or a network server, the POS system is organized into the following three modules: a face detection module which detects the above viewer's facial area from the image extracted from the image input via an image input apparatus installed at the task location of a POS terminal; a facial feature point detection module which detects a facial feature point from the facial area extracted above; a customer information generation module which estimates at least one of the information related to the above customer's gender and age based on the facial area and the facial feature point extracted above to generate personal information, wherein the above face detection module is characterized by following the five stages approach:
a first stage where a function of drawing up the YCbCr color model from the RGB color information of the above extracted image;
a second stage where separating color and brightness information from the color model drawn up;
a third stage where detecting a face candidate area according to the above brightness information; and
a fourth stage where a function of defining the rectangular feature point model about the above detected face candidate area; and the last stage whrer detecting a facial area based on the learning data which the above rectangular feature point model is learned through an AdaBoost learning algorithm.

17. The method according to claim 16 for generating customer's personal information wherein a statistics generation module correlates at least more than two of the information related to each customer's gender, age, purchasing time and product to generate statistical information is included in the device described in (claim 16).

18. The method according to claim 17 for generating customer's personal information wherein the above information about purchasing time or product in is recognized from the above POS terminal.

19. A device for generating customer's personal information for a POS system composed of POS terminals and all the servers or a network server wherein the device is characterized by the following five stages approach and through the stages; the above customer's facial area is detected from the image extracted from the image input via an image input apparatus installed at the task location of the customer response terminal to generate customer's personal information about at least one of the above customer's gender and age, the five stages comprising; a first stage where a function of drawing up the YCbCr color model from the RGB color information of the above extracted image;
a second stage where separating color and brightness information from the color model drawn up;
a third stage where detecting a face candidate area according to the above brightness information;
a fourth stage where a function of defining the rectangular feature point model about the above detected face candidate area; and
a last stage where detecting a facial area based on the learning data which the above rectangular feature point model is learned through an AdaBoost learning algorithm.

20. A is a device for generating customer's personal information for a POS system composed of POS terminals and all the servers or a network server, wherein the device is characterized by a five stages approach and through the stages; the above customer's facial area is detected from the image extracted from the image input via an image input apparatus installed at the task location of the customer response terminal to generate customer's personal information about at least one of the above customer's gender and age the five stages comprising:
a first stage where a function of drawing up the YCbCr color model from the RGB color information of the above extracted image;
a second stage where separating color and brightness information from the color model drawn up;
a third stage where detecting a face candidate area according to the above brightness information;
a fourth stage where a function of defining the rectangular feature point model about the above detected face candidate area; and
a last stage where detecting a facial area based on the learning data which the above rectangular feature point model is learned through an AdaBoost learning algorithm.
